(19) United States
(12) Patent Application Publication
(10) Pub. No.: US 2009/0122784 A1
(43) Pub. Date: May 14, 2009

(54) METHOD AND DEVICE FOR IMPLEMENTING THE SECURITY OF THE BACKBONE NETWORK

(76) Inventor: Yikang Lei, Guangdong Province (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/916,638

(22) PCT Filed: Jun. 2, 2006
(86) PCT No.: PCT/CN2006/001188

§ 371 Date: Jun. 26, 2008

(30) Foreign Application Priority Data
Jun. 6, 2005 (CN) 200510074932.1

(51) Int. Cl. H04L 12/28

(52) U.S. Cl. 370/351

(57) ABSTRACT

A method for implementing backbone network security, includes: when an edge device in a backbone network receives a packet, modifying TTL value in the packet received to a value different from a TTL value which is to be used in the packet in the backbone network, and sending the packet modified; identifying the packet from the client on the device in the backbone network according to the TTL value in the packet received and performing a security process.

### FIELD OF THE INVENTION

The present invention relates to the technical field of network communications, and in particular, to a method and a device for implementing backbone network security.

### BACKGROUND OF THE INVENTION

With the rapid development of network communication technologies, telecommunication services and multimedia services, such as the television service, provided on Internet Protocol (IP) network become wider and wider. When various telecommunication services are provided via an IP-based network, providers and users will certainly require the IP network can reach or gradually reach a security performance of the telecommunication class.

According to the conventional networking structure, a router is one of core components of an IP network and the whole IP network can operate securely only when the secure operation of the router is guaranteed. Therefore, various security mechanisms of the router, especially the carrier-class security mechanism are gaining more and more attention.

Moreover, with the popularization of network and the toolization of attack, various attacks are becoming more and more common, and the skill requirement for attackers are becoming lower and lower. At present, attacks on network which are difficult to be prevented from include Distributed Deny of Service (DDoS) Attack. The DDos attack is a prevalent Hacker attack mode on the current network. In this attack mode, many nodes in different network domains may be controlled to fabricate various protocol packets which seem valid and to send these packets to an attacked object at the same time. Thus resources of the attacked object will be exhausted. Particularly, resources which are easy to form a bottleneck will be exhausted, such as Central Processing Unit (CPU) resources, memory resources and bandwidth resources. As a result, the attacked object will be disabled to process normal requests.

As an important network element in the IP network, routers are gradually becoming attack objects of the DDoS Attack. To strength the carrier-class security of a router, the DDoS attack must be prevented on the router as much as possible.

At present, according to some protocols, the DDoS attack which makes the protocol stack unable to run normally by consuming CPU resources is usually prevented by using The Time to Live (TTL) field of an IP packet. For example, Generalized TTL Security Mechanism (GTSM) may be employed.

In the GTSM solution, based on the proposal in RFC 3682, various DDoS attacks on protocols which need to establish sessions are prevented on a router according to TTL (or called Hop Limit). In this solution, when sessions established need protocols of multiple hops, considerations will be made according to various situations one by one.

The principles of the conventional GTSM for providing security features are now introduced.

FIG. 1 shows the situation that the DDoS attack is considered. In FIG. 1, the unidirectional solid arrow represents the bogus Label Distribution Protocol (LDP) packet stream from each attack point 100 with the destination of router 120. In FIG. 1, each controlled network node (attack point 100) synchronously sends bogus LDP packets with destination address as router 120 and source address as router 130 (i.e., one party of an LDP PEER), to router 120 at the other party of the LDP PEER. In the case that no GTSM mechanism is implemented, router 120 forwards all received attack packets to the routing engine of router 120. Thus the CPU resources of the routing engine of router 120 may be exhausted.

When the GTSM mechanism is implemented, the DDoS attack may be prevented on a router as follows.

The router subtracts 1 from the TTL value on each IP (IPv6 or IPv4) packet which is forwarded normally at the egress. The maximum value of TTL is 255.

Moreover, most protocol peerings are established between adjacent routers, including physically adjacent routers or logically adjacent routers, for example, two routers at the two ends of a tunnel.

Therefore, for a peering established between physically adjacent routers, when a packet sent from one party of the peering arrives at the other party of the peering, the TTL value of the packet keeps unchanged. For example, if the TTL value of a packet is 255 when the packet is sent from the source, the TTL value of the packet is 255 when the packet arrived at the destination. For a bogus packet which is sent from a non-peering network node to a party of a peering (in most of the cases, the source address is filled in as the address of the peer party of the peering), the bogus packet usually arrives at the destination via several routers. Because the TTL value of the packet is decreased by 1 each time when the packet passes through a router, the TTL value of the packet arrived is smaller than 255 no matter what value is filled in the TTL field when the packet is sent. Thus, the validity of the protocol packet arrived may be determined according to the TTL value on the forwarding plane. Invalid packets may be filtered out, to alleviate the load of the control plane processor, and to guarantee the normal operation of the protocol stack.

For a peering established between logically adjacent routers, after a packet sent from one party of the peering (the TTL value is 255 when the packet is sent out) arrives at the other party of the peering, the TTL value ranges from 255 to (255-TrustRadius). In such condition, if the TTL value of the protocol packet arrived at the router is out of the range, it may be determined that the packet is invalid. Therefore, by employing such a mechanism, the normal operation of the protocol stack may be protected.

The above method is effective at the early stage of a networking process, because the validity of a packet may be determined according to the range of the TTL value. However, in a complex 3-layer Virtual Private Network (VPN) such as MultiProtocol Label Switching (MPLS) network shown in FIG. 2, Provide Device (P device) 212 and Provide Edge Device (PE device) 222 may be used in combination. It is difficult to dispose GTSM policy, because the difference between TTL values of packets forwarded from different PE devices is very large. For example, the router of P node 212 shown in FIG. 2 cannot distinguish a valid packet from PE node 222 from an invalid packet from Customer Edge Device (CE) node 232 according to the TTL value. Therefore, the above method may cause the complexity and coupling of the disposition policy, and the disposition difficulty for a complex network can well be imagined. Moreover, configuration adjustment needs to be carried out each time when the network is extended or modified, so the difficulty of maintenance is increased greatly.

In addition to the above 3-layer MPLS network, the above problem also exists in a backbone network including routers. For example, the routing network shown in FIG. 3 includes backbone device 310, edge device 320 and user device 330. Because the path from different edge device 320 to different backbone device 310 is inconsistent, there also arises a problem on the disposition of the GTSM policy.

Therefore, the expected prevention function cannot be implemented in many existing networks via GTSM, or the implementation is very complex.

Additionally, the protection mode for backbone devices also includes protection solutions based on a single device. In the protection solutions based on a single device, a complex Access Control List (ACL) and various complex leaky buckets need to be applied. Therefore the complexity of the networking and configuration may increase. Moreover, each leaky bucket is small for resisting the composite attack. Thus, the normal performance of the device will also be influenced.

In conclusion, in the prior art, because the core device in the backbone network cannot effectively distinguish packets in the backbone network from packets sent from a device outside the backbone network, data outside the backbone network with high risk cannot be effectively identified, and a corresponding security process cannot be implemented.

### SUMMARY OF THE INVENTION

The present invention provides a method and a device for implementing backbone network security, so that the core device in the backbone network may effective identify the data sent from a device outside the backbone network, thereby improving the security performance of the network.

One aspect of the invention provides a method for implementing backbone network security, including:

after an edge device in a backbone network receives a packet, configuring an ID information in a packet received for distinguishing the packet received from a packet in the backbone network and sending the packet received; and

identifying, by a device in the backbone network, a packet sent from a device outside the backbone network according to the ID information in the packet received, and performing a security process.

The process for configuring the ID information includes:

modifying the TTL value in the packet received to a value different from a TTL value which is to be used in the packet in the backbone network.

The method further includes:

during transmitting the packet sent from the device outside the backbone network in the backbone network, a variation range of the TTL value in the packet sent from the device outside the backbone network does not overlap with the range of the TTL value in the packet in the backbone network.

The process for configuring the ID information includes:

modifying the TTL value in the packet sent from the device outside the backbone network to a value not greater than a TTL upper limit value, and the TTL upper limit value is determined according to the TTL value which is to be used in the packet in the backbone network.

The process for configuring the ID information includes:

comparing the TTL value in the packet sent from the device outside the backbone network with the TTL upper limit value; if the TTL value in the packet is greater than the TTL upper limit value, modifying the TTL value in the packet to the TTL upper limit value; otherwise, subtracting 1 from the TTL value in the packet.

The process for identifying the packet sent from a device outside the backbone network includes:

after receiving the packet by a device in the backbone network, comparing the TTL value in the packet received with a TTL lower limit value; if the TTL value in the packet received is smaller than the TTL lower limit value, determining that the packet received is the packet sent from the device outside the backbone network; otherwise, determining that the packet received is a packet in the backbone network, and delivering the packet received to an upper layer for processing.

The TTL lower limit value is greater than the TTL upper limit value.

The security process includes:

discarding the packet sent from the device outside the backbone network.

The security process includes:

obtaining characteristic information in the packet received; and

determining whether the packet received is valid according to the characteristic information and valid packet information recorded; if the packet received is valid, delivering the packet received to the upper layer for processing; otherwise, discarding the packet received.

The characteristic information includes:

at least one of a source address, a destination address, a source port and destination port information of the packet received.

The valid packet information is recorded in an Access Control List (ACL) of a device in the backbone network.

The process for configuring the ID information includes:

modifying the QoS value or the ToS value in the packet received to a value different from the QoS value or the ToS value which is to be used in the packet in the backbone network

The method further includes: configuring the ID information in the edge device of a client end.

Another aspect of the invention provides a backbone network edge device, including: a receiving unit configured to receive a packet sent from a device outside the backbone network; an ID information configuring unit, configured to configure ID information in the packet send from a device outside the backbone network for distinguishing the packet sent from the device outside the backbone network from a packet in the backbone network; and a sending unit, configured to send a packet with the ID information configured.

The ID information configuring unit is a TTL configuring unit or a QoS and/or ToS configuring unit.

Another aspect of the invention provides a backbone network device, including: a receiving unit configured to receive a packet from a backbone network edge device; an identifying unit, configured to identify a packet sent from a device outside the backbone network according to ID information in a packet received; and a security processing unit, configured to perform a security process on the packet sent from a device outside the backbone network.

The identifying unit is a TTL identifying unit or a QoS and/or ToS identifying unit.

It can be seen from the above technical solutions of the present invention that, by the invention, data outside the backbone network and data inside the backbone network may be identified respectively, so that all attacks outside the backbone network may be easily identified and filtered on the backbone network device. Thus the security problem of a backbone network device may be solved. Moreover, during the implementation of the invention, an easy deployment is realized, in other words, the invention may be implemented by configuring only once after being planned uniformly.

Additionally, during the implementation of the invention, the requirements of different networking and the requirements of some clients on the access of the backbone network device may be met by combining an ACL or adjusting the TTL on a CE node of the provider.

### BRIEF DESCRIPTION OF THE DRAWINGS

FIG. 1 is a schematic diagram showing a DDoS attack in the prior art;

FIG. 2 is a schematic diagram showing the MPLS networking in the prior art;

FIG. 3 is a schematic diagram showing the networking of a routing network in the prior art;

FIG. 4 is a schematic diagram showing the processing for an edge device according to one embodiment of the invention; and

FIG. 5 is a schematic diagram showing the processing for a backbone network device according to one embodiment of the invention.

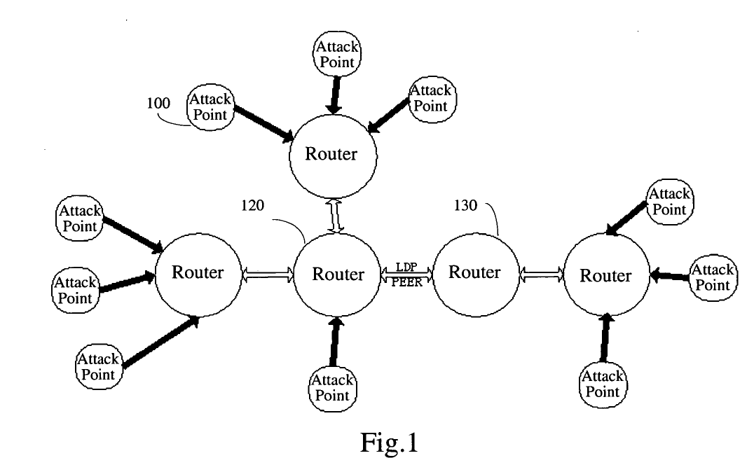

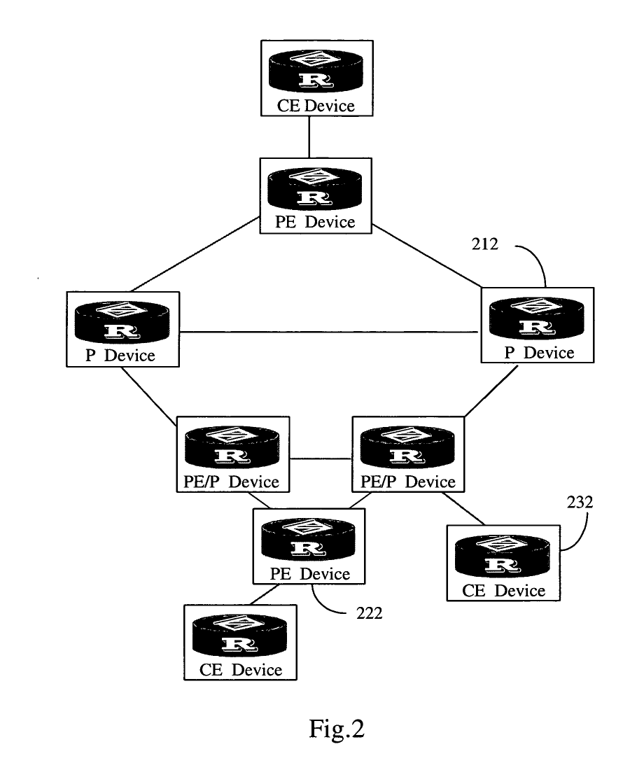

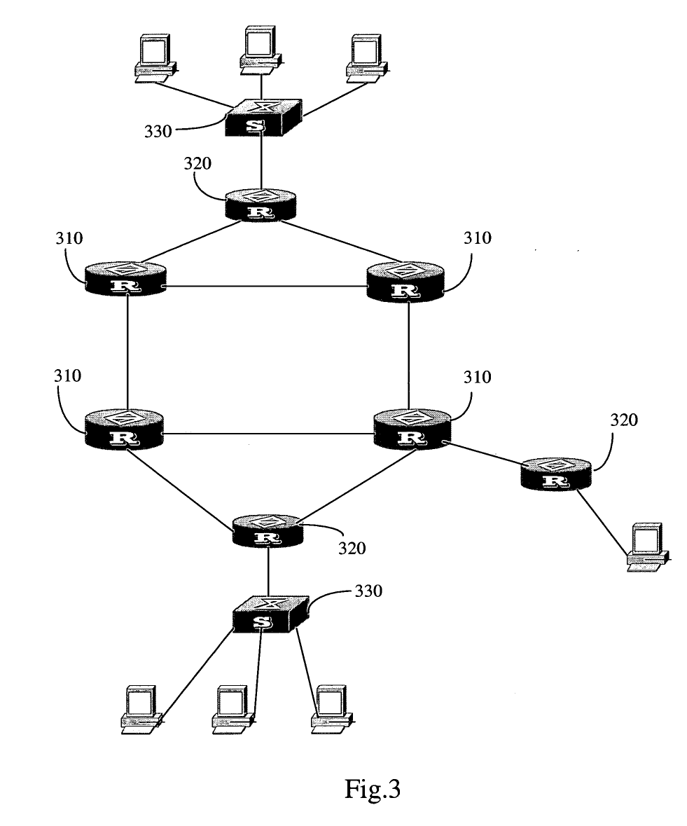

### DETAILED DESCRIPTION OF THE EMBODIMENTS

The invention provides an easy and simple method for solving the security problem of the backbone network in complex networks. In other words, for protecting a device in the backbone network, especially a P device (i.e., a device on the backbone network) from being attacked by any attack from the user, thereby guaranteeing the security of the backbone network.

The main concept of the invention lies in that, a distinguish ID is attached to an IP packet sent from a client on an edge routing device to identify a packet from the user side which needs to be prevented, so that the packet from the user side which needs to be prevented may be distinguished from a valid IP packet from the backbone network. Hence, the security guarantee may be provided to the routing device in the backbone network.

In one embodiment, the edge routing device may modify the TTL value of an IP packet from a client, so that the IP packet from a client may be distinguished from an IP packet from the backbone network. Therefore the corresponding security guarantee may be provided to the routing device in the backbone network. In other words, the routing device in the backbone network may determine the validity of a received packet according to the TTL value of the packet and a corresponding TTL threshold, therefore guaranteeing the security of the backbone network.

In other embodiments, the edge routing device may distinguish a valid packet from an invalid packet by different packet Quality of Service (QoS) values or Type of Service (ToS) values. For example, a specific bit of the QoS or ToS field may be used to distinguish different packets, and so on. So that the core network device may be easily identified and processed packets which need to be prevented.

Because devices in the backbone network are usually provider devices and are controlled and disposed by the provider uniformly and the attacks are mostly initiated from the CE side. The situation that an attack is initiated from the backbone network hardly exists. Therefore, if a packet from the CE and a packet from the backbone network (i.e., a packet from the PE device and a packet from the P device) can be well identified, the backbone network device may process different packets distinctively, thus may easily prevent an attack from the CE.

A PE device directly connected with a CE can easily identify the packet sent from the CE device. Therefore, if the PE device attaches a CE flag which is easily identified to the packet, the validity control on the packet may be implemented.

The invention will now be illustrated in detail with modifying the TTL value as an example.

In one embodiment of the invention, considering that each IP packet has a TTL field which needs to be modified by an intermediate network device to prevent a loop, a TTL upper limit value TTL_USER_MAX of the user packet may be set on an edge device of the backbone network, and a TTL lower limit value TTL_ACCEPT_MIN identifying a packet acceptable may be set on all network devices of the backbone network. The value of TTL_ACCEPT_MIN should be greater than the value of TTL_USER_MAX. The edge device guarantees the TTL values of all IP packets from the users are not greater than TTL_USER_MAX. Thus, the network device security may be implemented.

Embodiments of the method according to the invention will now be illustrated in detail in conjunction with the drawings.

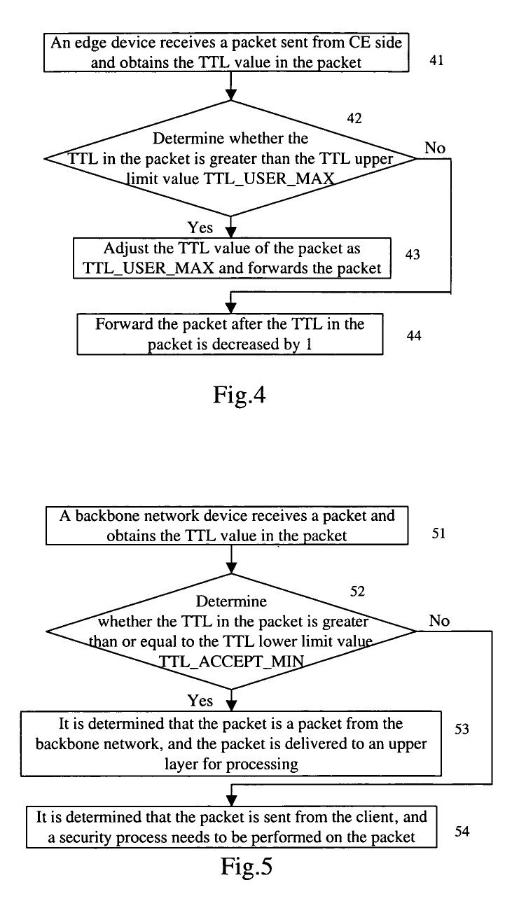

First of all, FIG. 4 shows a process for processing a packet from the CE or a user by a PE node or a backbone network edge device according to an embodiment of the invention, including the following blocks.

Block 41: An edge device receives a packet from the CE side and obtains a TTL value from the packet.

Block 42: It is determined whether the TTL value is greater than the TTL upper limit value TTL_USER_MAX. If the TTL value is greater than the TTL upper limit value TTL_USER_MAX, the process turns to Block 43; otherwise, the process turns to Block 44.

Block 43: The TTL value of the packet is set to TTL_USER_MAX and the packet is forwarded.

The key process of this embodiment of the invention is that the TTL value in the packet is changed in this step, so that the TTL value of the packet sent from a user is different from the TTL value of the packet in the backbone network. Thus the routing device of the backbone network may easily distinguish the packet from the user from the packet from the backbone network device, thereby may process the packet from the user with a potential danger separately.

In other words, in this embodiment of the invention, by this step, it needs to be guaranteed that, during the packet sent from the client is transmitted in the backbone network, the variation range of the TTL value in the packet sent from the client should not overlap with the range of the TTL value in a packet in the backbone network. Thus, the backbone network device may be able to effectively find the packet sent from the client with a potential security danger, so that a corresponding filtration process may be carried out.

In one embodiment of the invention, the value of TTL_USER_MAX is determined according to the TTL value which may be applied to an internal packet in the backbone network. For example, if the TTL value which may be applied to the internal packet in the backbone network ranges from 255 to 200, the value of TTL_USER_MAX should be set as smaller than 200, for example, the value of TTL_USER_MAX may be set as 160, 150 and so on.

Block 44: After the TTL value in the packet is decreased by 1, the packet is forwarded, i.e., a normal forwarding process is performed on the packet.

FIG. 5 shows a process for processing a received packet on a PE/P node or a backbone network device, including the following blocks.

Block 51: A backbone network node device receives a packet and obtains a TTL value from the packet.

Block 52: It is determined whether the TTL value in the packet is greater than or equal to the TTL lower limit value TTL_ACCEPT_MIN. If the TTL in the packet is greater than or equal to the TTL lower limit value TTL_ACCEPT_MIN, the process turns to Block 53; otherwise, the process turns to Block 54.

Block 53: If the TTL in the packet is greater than or equal to the TTL lower limit value TTL_ACCEPT_MIN, it is determined that the packet is a packet from the backbone network and the packet is transmitted to an upper layer for processing.

Block 54: If the TTL in the packet is less than the TTL lower limit value TTL_ACCEPT_MIN, it is determined that the packet is a packet from the client a security process needs to be performed on the packet.

Specifically, the method for performing the security process includes the following two types.

1) All packets from the backbone network are regarded as invalid packets, i.e., packets with the potential danger, and the packets are discarded directly. Therefore, the security of the backbone network device is guaranteed, and then the security of the backbone network is guaranteed.

2) An ACL may also be configured for the packets from the client, so that a filtration process may be performed on the packets from the client with the potential danger.

The ACL may include characteristic information of a valid packet. Specifically, the characteristic information may include at least one of a source address, a destination address, a source port and destination port information. After the backbone network device receives a packet, the backbone network device may compare characteristic information in the packet received with the characteristic information of the valid packet in the ACL, and filter out the invalid packets. So that only the valid packets are delivered to the upper layer for processing. Thus, in combination with the ACL in a device, the present disclosure can met the requirement of different networking and the requirements of some clients on the access of the backbone network device.

In other words, if a node allows some special accesses, a corresponding ACL may be configured. When the TTL value in the packet is smaller than the value of TTL_ACCEPT_MIN, a filtration process needs to be further performed on the packet according to the configured ACL, and then the valid packets will be delivered to the upper layer for processing and the invalid packets will be discarded.

In an embodiment, it may be further determined that whether a TTL value adjustment needs to be performed on a CE node of the provider, so as to meet the requirements of different networking and the requirements of some clients on the access of the backbone network device.

In conclusion, in the disclosure, because the number of hops of a packet forwarded from the backbone network is various, by modifying the TTL lower limit value TTL_ACCEPT_MIN and the TTL upper limit value TTL_USER_MAX to an appropriate value, the user application and the internal communication of the backbone network may not be influenced.

Therefore, in the disclosure, data from a user (the CE side) and data from the backbone network can be identified and distinguished, so that attacks from the user are easily identified and further filtered out on the backbone network device. Thus the security problem of the backbone network device is solved. Moreover, during the implementation of the invention, an easy deployment is realized, in other words, the invention may be implemented by configuring only once after being planned uniformly.

The backbone network edge device according to the present disclosure includes: a receiving unit, configured to receive a packet sent from a device outside the backbone network; an ID information configuring unit, configured to configure ID information in the packet send from the device outside the backbone network for distinguishing the packet sent from the device outside the backbone network from a packet in the backbone network; and a sending unit, configured to send a packet with the ID information configured.

The ID information configuring unit is a TTL configuring unit or a QoS and/or ToS configuring unit.

The backbone network device according to the disclosure includes: a receiving unit, configured to receive a packet from the backbone network edge device; an identifying unit, configured to identify a packet outside the backbone network according to the ID information in the packet; and a security processing unit, configured to perform a security process on the packet outside the backbone network.

The identifying unit is a TTL identifying unit or a QoS and/or ToS identifying unit.

It should be noted that the disclosure is configured to identify all the data outside the backbone network, without being limited to the data from a client as described in the embodiments.

Additional advantages and modifications will readily occur to those skilled in the art. Therefore, the invention in its broader aspects is not limited to the specific details and representative embodiments shown and described herein. Accordingly, various modifications and variations may be made without departing from the scope of the invention as defined by the appended claims and their equivalents.

1-17. (canceled)

18. A method for processing packets, comprising:
receiving, by an edge device in a backbone network, a packet from a device outside the backbone network;
setting ID information indicating the packet from a device outside the backbone network into the packet; and
sending the packet.

19. The method according to claim 18, wherein, the process of setting the ID information comprises:
modifying The Time to Live, TTL, value in the packet to a value different from a first TTL value which is to be used in an internal packet in the backbone network.

20. The method according to claim 19, wherein, the process of modifying the TTL value in the packet comprises:
modifying the TTL value to a value not greater than a TTL upper limit value, wherein the TTL upper limit value is determined according to the first TTL value which is to be used in the internal packet in the backbone network.

21. The method according to claim 20, wherein, the process of modifying the TTL value in the packet comprises:
comparing the TTL value in the packet with the TTL upper limit value; if the TTL value is greater than the TTL upper limit value, modifying the TTL value in the packet to the TTL upper limit value; otherwise, subtracting 1 from the TTL value.

22. The method according to claim 18, wherein, the process of setting the ID information comprises:
modifying a QoS value in the packet to a value different from a first QoS value which is to be used in an internal packet in the backbone network.

23. The method according to claim 18, wherein, the process of setting the ID information comprises:
modifying a ToS value in the packet to a value different from a first ToS value which is to be used in an internal packet in the backbone network.

24. A method for processing packets, comprising:
receiving, by a device in the backbone network, a packet, wherein the packet containing ID information indicates the packet from a device outside the backbone network;
identifying the packet from a device outside the backbone network according to the ID information in the packet; and
performing a security process.

25. The method according to claim 24, wherein, the process of identifying the packet from a device outside the backbone network comprises:
comparing a TTL value in the packet with a TTL lower limit value; if the TTL value in the packet is smaller than the TTL lower limit value, determining that the packet received is the packet sent from the device outside the backbone network.

26. The method according to claim 25, further comprising:
if the TTL value in the packet is greater than or equal to the TTL lower limit value, determining that the packet received is an internal packet in the backbone network; and
transferring the packet to an upper layer for processing.

27. The method according to claim 24, wherein, the security process comprises:
discarding the packet.

28. The method according to claim 24, wherein, the security process comprises:
obtaining characteristic information in the packet; and
determining whether the packet received is valid according to the characteristic information and valid packet information; if the packet received is valid, transferring the packet received to the upper layer for processing; if the packet received is not valid, discarding the packet.

29. The method according to claim 28, wherein, the characteristic information comprises:
at least one of a source address, a destination address, a source port and destination port information of the packet.

30. The method according to claim 28, wherein the valid packet information is recorded in an Access Control List.

31. A backbone network edge device, comprising a receiving unit configured to receive a packet sent from a device outside the backbone network, wherein the backbone network edge device further comprises:
an ID information configuring unit, configured to configure ID information in the packet sent from a device outside the backbone network for distinguishing the packet sent from the device outside the backbone network from an internal packet in the backbone network; and
a sending unit, configured to send a packet with the ID information configured.

32. The backbone network edge device according to claim 31, wherein, the ID information configuring unit is a TTL configuring unit or a Quality of Service, QoS, and/or Type of Service, ToS, configuring unit.

33. A backbone network device comprising a receiving unit configured to receive a packet from a backbone network edge device, wherein the backbone network device further comprises:
an identifying unit, configured to identify a packet sent from a device outside the backbone network according to ID information in a packet received; and
a security processing unit, configured to perform a security process on the packet sent from a device outside the backbone network.

34. The backbone network device according to claim 33, wherein, the identifying unit is a TTL identifying unit or a Quality of Service, QoS, and/or a Type of Service, ToS, identifying unit.

35. A system comprising:
a backbone network edge device communicating with a backbone network device, wherein, the backbone network edge device is capable of:
receiving, by an edge device in a backbone network, a packet from a device outside the backbone network;
setting ID information indicating the packet from a device outside the backbone network into the packet; and
sending the packet.

36. The system according to claim 35, wherein the backbone network edge device is capable of:
modifying a TTL value in the packet to a value different from a first TTL value which is to be used in an internal packet in the backbone network.

37. The system according to claim 36, wherein the backbone network edge device is capable of:
modifying the TTL value to a value not greater than a TTL upper limit value, wherein the TTL upper limit value is determined according to the first TTL value which is to be used in the internal packet in the backbone network.

38. The system according to claim 35, wherein the backbone network edge device is capable of:
modifying a QoS or ToS value in the packet to a value different from a first QoS OR ToS value which is to be used in an internal packet in the backbone network.

39. A system comprising:
a backbone network device communicating with a backbone network edge device, wherein, the a backbone network device is capable of:
receiving, by a device in the backbone network, a packet, wherein the packet contains ID information indicating the packet from a device outside the backbone network;
identifying the packet from a device outside the backbone network according to the ID information in the packet; and
performing a security process.

40. The system according to claim 39, wherein the backbone network device is capable of:
comparing a TTL value in the packet with a TTL lower limit value; if the TTL value in the packet is smaller than the TTL lower limit value, determining that the packet received is the packet sent from the device outside the backbone network.

41. The method according to claim 39, wherein the backbone network device is capable of:
discarding the packet.

42. The method according to claim 39, wherein the backbone network device is capable of:
obtaining characteristic information in the packet; and
determining whether the packet received is valid according to the characteristic information and valid packet information; if the packet received is valid, transferring the packet received to the upper layer for processing; if the packet received is not valid, discarding the packet.
